(19) United States
(12) Patent Application Publication
(10) Pub. No.: US 2024/0260017 A1
(43) Pub. Date: Aug. 1, 2024

(54) MULTI-ACCESS POINT PRIMARY CHANNEL SWITCHING

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US)

(73) Assignee: Ofinno, LLC, Reston, VA (US)

(21) Appl. No.: 18/427,890

(22) Filed: Jan. 31, 2024

Related U.S. Application Data
(60) Provisional application No. 63/442,473, filed on Feb. 1, 2023.

(51) Int. Cl. H04W 72/0453; H04W 72/27; H04W 74/0816

(52) U.S. Cl. CPC H04W 72/0453; H04W 72/27; H04W 74/0816

(57) ABSTRACT

A first access point (AP) transmits to a second AP a first frame comprising a request to the second

AP to switch a channel of operation from a first channel to a second channel. The first AP and the second AP may be members of a coordinated AP set. The first AP receives from the second AP a second frame comprising one of: an indication of acceptance or rejection of the request or an indication of a third channel. The first AP transmits to one or more associated stations a third frame indicating, based on the second frame: the first channel as the channel of operation or a switch of the channel of operation from the first channel to the second channel or to the third channel.

### CROSS-REFERENCE TO RELATED APPLICATIONS

This application claims the benefit of U.S. Provisional Application No. 63/442,473, filed Feb. 1, 2023, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example multi-AP network.

FIG. 4 illustrates an example network that includes a coordinated AP set.

FIG. 5 illustrates an Extended Channel Switch Announcement element.

FIG. 6 illustrates an Extended Channel Switch Announcement Action field.

FIG. 7 is an example that illustrates a procedure that may be used by an AP to switch a channel of operation.

FIG. 8 is an example that illustrates primary channel switching in a coordinated AP set.

FIG. 9 is an example that illustrates a potential problem that may arise in relation to primary channel switching in a coordinated AP set.

FIG. 10 is an example that illustrates another potential problem that may arise in relation to primary channel switching in a coordinated AP set.

FIG. 11 is an example that illustrates a first proposed procedure for primary channel switching in a coordinated AP set according to an embodiment.

FIG. 12 is another example that illustrates the first proposed procedure for primary channel switching according to an embodiment.

FIG. 13 is an example that illustrates a second proposed procedure for primary channel switching in a coordinated AP set according to an embodiment.

FIG. 14 illustrates an example Extended Channel Switch Announcement Action field according to an embodiment.

FIG. 15 illustrates an example CS Request frame according to an embodiment.

FIG. 16 illustrates an example process according to an embodiment.

FIG. 17 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may for example.” In other words, the term “may” is indicative that the phrase following the term “may” is an example of one of a multitude of suitable possibilities that may or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may or may not, be employed to one or more of the various embodiments. The phrase “in response to” (or equally “in response at least to”) is indicative that the phrase following the phrase “in response to” is an example of one of a multitude of suitable possibilities that may or may not, be employed to one or more of the various embodiments. The phrase “depending on” (or equally “depending at least to”) is indicative that the phrase following the phrase “depending on” is an example of one of a multitude of suitable possibilities that may or may not, be employed to one or more of the various embodiments. The phrase “employing/using” (or equally “employing/using at least”) is indicative that the phrase following the phrase “employing/using” is an example of one of a multitude of suitable possibilities that may or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

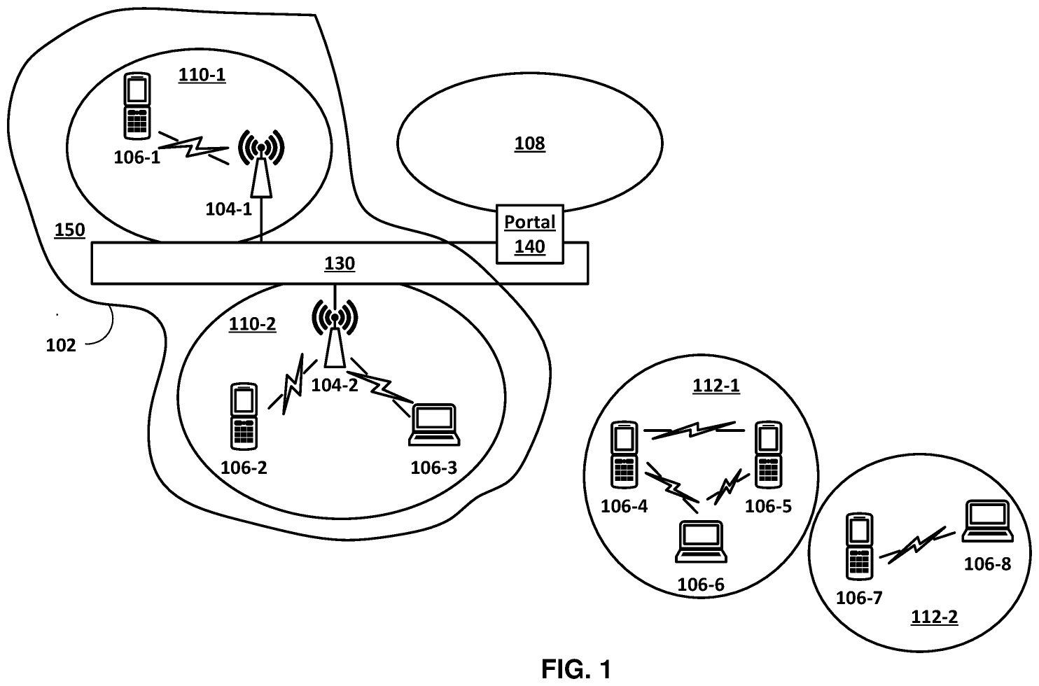

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

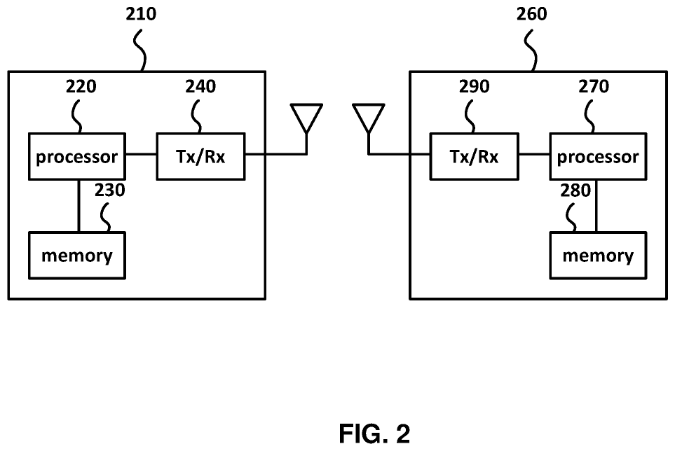

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

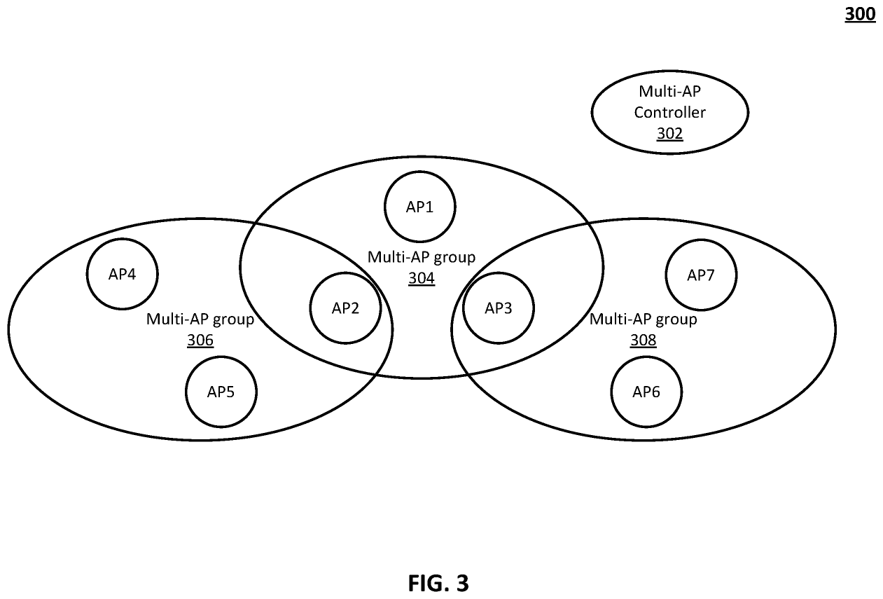

FIG. 3 illustrates an example multi-AP network 300. Example multi-AP network 300 may be a multi-AP network in accordance with the Wi-Fi Alliance standard specification for multi-AP networks. As shown in FIG. 3, multi-AP network 300 may include a multi-AP controller 302 and a plurality of multi-AP groups (or multi-AP sets) 304, 306, and 308.

Multi-AP controller 302 may be a logical entity that implements logic for controlling the APs in multi-AP network 300. Multi-AP controller 302 may receive capability information and measurements from the APs and may trigger AP control commands and operations on the APs. Multi-AP controller 302 may also provide onboarding functionality to onboard and provision APs onto multi-AP network 300.

Multi-AP groups 304, 306, and 308 may each include a plurality of APs. APs in a multi-AP group are in communication range of each other. However, the APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, one of the APs in a multi-AP group may be designated as a master AP. The designation of the master AP may be done by AP controller 302 or by the APs of the multi-AP group. The master AP of a multi-AP group may be fixed or may change over time between the APs of the multi-AP group. An AP that is not the master AP of the multi-AP group is known as a slave AP.

In one approach, APs in a multi-AP group may coordinate with each other, including coordinating transmissions within the multi-AP group. One aspect of coordination may include coordination to perform multi-AP transmissions within the multi-AP group. As used herein, a multi-AP transmission is a transmission event in which multiple APs (of a multi-AP group or a multi-AP network) transmit simultaneously over a time period. The time period of simultaneous AP transmission may be a continuous period. The multi-AP transmission may use different transmission techniques, such as Coordinated OFDMA, Coordinated Spatial Reuse, Joint Transmission and Reception, Coordinated Beamforming and Coordinated Time Division Multiple Access (TDMA), or a combination of two or more of the aforementioned techniques.

Multi-AP group coordination may be enabled by the AP controller and/or by the master AP of the multi-AP group. In one approach, the AP controller and/or the master AP may control time and/or frequency sharing in a transmission opportunity (TXOP). For example, when one of the APs (e.g., the master AP) in the multi-AP group obtains a TXOP, the AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

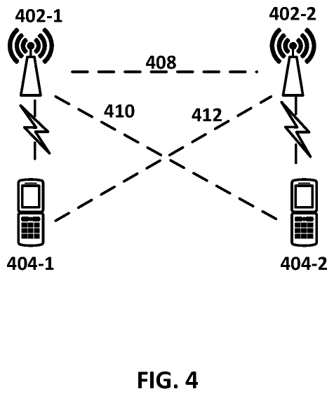

FIG. 4 illustrates an example network 400 that includes a coordinated AP set. As shown in FIG. 4, the coordinated AP set may include two APs-AP 402-1 and AP 402-2. At least one STA may be associated with each of APs 402-1 and 402-2. For example, a STA 404-1 may be associated with AP 402-1, and a STA 404-2 may be associated with AP 402-2.

APs 402-1 and 402-2 may be long to the same ESS as described above in FIG. 1. In such a case, APs 402-1 and 402-2 may be connected by a DS to support ESS features. In addition, as part of a coordinated AP set, APs 402-1 and 402-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 402-1 and 402-2 may act as a Master AP and the other as a Slave AP. The Master AP is the AP that is the owner of the TXOP. The Master AP shares frequency resources during the TXOP with the Slave AP. When there are more than two APs in the coordinated set, a Master AP may share its TXOP with only a subset of the coordinated AP set. The role of the Master AP may change over time. For example, the Master AP role may be assigned to a specific AP for a duration of time. Similarly, the Slave AP role may be chosen by the Master AP dynamically or can be pre-assigned for a duration of time.

Spatial reuse with AP coordination across multiple BSSs (known as Coordinated Spatial Reuse (CSR)) can be more stable than non-AP coordinated spatial reuse schemes such as OBSS PD-based SR and PSR-based SR. For example, in example 400, APs 402-1 and 402-2 may perform a joint sounding operation in order to measure path loss (PL) on paths of network 400. For example, the joint sounding operation may result in the measurement of PL 408 for the path between APs 402-1 and 402-2, path loss 410 for the path between AP 402-1 and STA 404-2, and path loss 412 for the path between AP 402-2 and STA 404-1. The measured path loss information may then be shared between APs 402-1 and 402-2 (e.g., using the backhaul) to allow for simultaneous transmissions by APs 402-1 and 402-2 to their associated STAs 404-1 and 404-2 respectively. Specifically, one of APs 402-1 and 402-2 obtains a TXOP to become the Master AP. The Master AP may then send a CSR announcement frame to the other AP(s). In an embodiment, the Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

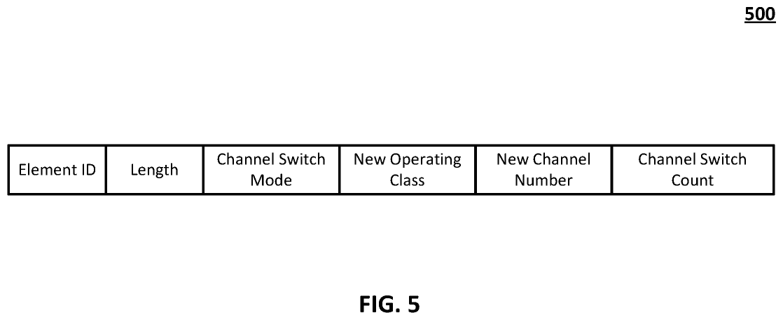

FIG. 5 illustrates an Extended Channel Switch Announcement element 500. Extended Channel Switch Announcement element 500 may be carried in a beacon frame or a management frame, for example. Extended Channel Switch Announcement element 500 may be used by an AP to advertise when a BSS of the AP is changing to a new channel in a same or a new operating class. The announcement includes both an operating class and a channel number of the new channel. As shown in FIG. 5, Extended Channel Switch Announcement element 500 includes an Element ID field, a Length field, a Channel Switch Mode field, a New Operating Class field, a New Channel Number field, and a Channel Switch Count field.

The Element ID and Length fields are defined in section 9.4.2.1 (General) of the IEEE standard (“IEEE P802.11-REVme/D2.0, October 2022.”)

The Channel Switch Mode field indicates any restrictions on transmission until a channel switch has been performed. An AP sets the Channel Switch Mode field to either 0 or 1 on transmission as specified in sections 11.8.8.2 (Selecting and advertising a new channel in a non-DMG infrastructure BSS) and 11.8.8.6 (Selecting and advertising a new channel in a DMG BSS) of the IEEE standard.

The New Operating Class field is set to a number of the operating class after the channel switch, as defined in Annex E of the IEEE standard.

If transmitted by an AP that is not an EDMG STA, the New Channel Number field is set to the number of the channel after the channel switch. The channel number is a channel from the new operating class of the AP as defined in Annex E of the IEEE standard. If transmitted by an AP that is an EDMG STA, the New Channel Number field is set to the channel number of the primary channel after the channel switch. The channel number is a channel from the new operating class of the AP as defined in Annex E in the IEEE standard.

For nonmesh STAs (e.g., an AP), the Channel Switch Count field indicates a number of target beacon transmission times (TBTTs) until the STA sending the Channel Switch Count field switches to the new channel. A Channel Switch Count field set to 1 indicates that the switch occurs immediately before the next TBTT. A Channel Switch Count field set to 0 indicates that the switch occurs any time after the frame containing the Channel Switch Count field is transmitted.

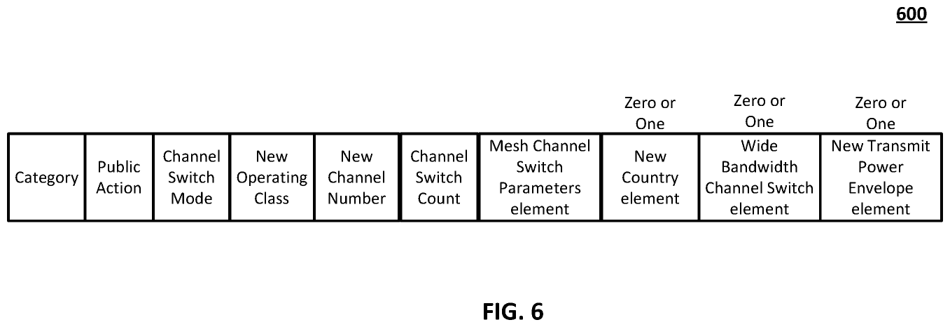

FIG. 6 illustrates an Extended Channel Switch Announcement Action field 600. Extended Channel Switch Announcement Action field 600 may be carried in an action frame serving as an Extended Channel Switch Announcement frame. The Extended Channel Switch Announcement frame may be used by an AP to advertise when a BSS of the AP is changing to a new channel in a same or a new operating class. As shown in FIG. 6, Extended Channel Switch Announcement Action field 600 includes a Category field, a Public Action field, a Channel Switch Mode field, a New Operating Class field, a New Channel Number field, a Mesh Channel Switch Parameters element, a New Country element, a Wide Bandwidth Channel Switch element, and a New Transmit Power Envelope element.

The Category field is defined in section 9.4.1.11 (Action field) of the IEEE standard.

The Public Action field is defined in section 9.6.7.1 (Public Action frames) of the IEEE standard.

The Channel Switch Mode, New Operating Class, New Channel Number, and Channel Switch Count fields are as described above with reference to FIG. 5 for the Extended Channel Switch Announcement element.

The Mesh Channel Switch Parameters element is defined in section 9.4.2.102 (Mesh Channel Switch Parameters element) of the IEEE standard. This element is present when a mesh STA performs MBSS channel switching. The Mesh Channel Switch Parameters element is not included for channel switching other than for an MBSS channel switch.

The New Country element is present when an AP or mesh STA performs extended channel switching to a new Country, new Operating Class Table, or a changed set of operating classes relative to the contents of the Country element sent in the Beacon; otherwise, this element is not present. The format of the New Country element is defined to be the same as the format of the Country element (defined in section 9.4.2.8 (Country element) of the IEEE standard), except that no Subband Triplet fields are present in the New Country element. The Country String field in the New Country element indicates the Country and Operating Class Table of the BSS after extended channel switching and Operating Triplet fields within the New Country element indicate the operating classes of the BSS after extended channel switching (see section 11.38.1 (Basic VHT BSS functionality) of the IEEE standard).

The Wide Bandwidth Channel Switch element is present when extended channel switching to a channel width wider than 40 MHz, or when extended channel switching is to a channel width wider than 1 MHz and the frame carrying the element is an S1G PPDU; otherwise, this element is not present. The Wide Bandwidth Channel Switch element is defined in section 9.4.2.160 (Wide Bandwidth Channel Switch element) of the IEEE standard. The Wide Bandwidth Channel Switch element indicates the BSS bandwidth after extended channel switching (see sections 11.38.1 (Basic VHT BSS functionality) and 10.46.1 (Basic S1G BSS functionality)).

The New Transmit Power Envelope element when present has the same format as the Transmit Power Envelope element (defined in section 9.4.2.161 (Transmit Power Envelope element)) and includes a distinct value of the Local Maximum Transmit Power Unit Interpretation subfield. If present, the New Transmit Power Envelope element indicates the maximum transmit powers for the BSS for the indicated bandwidths with an indicated unit interpretation after extended channel switching (see section 11.38.1 (Basic VHT BSS functionality) of the IEEE standard).

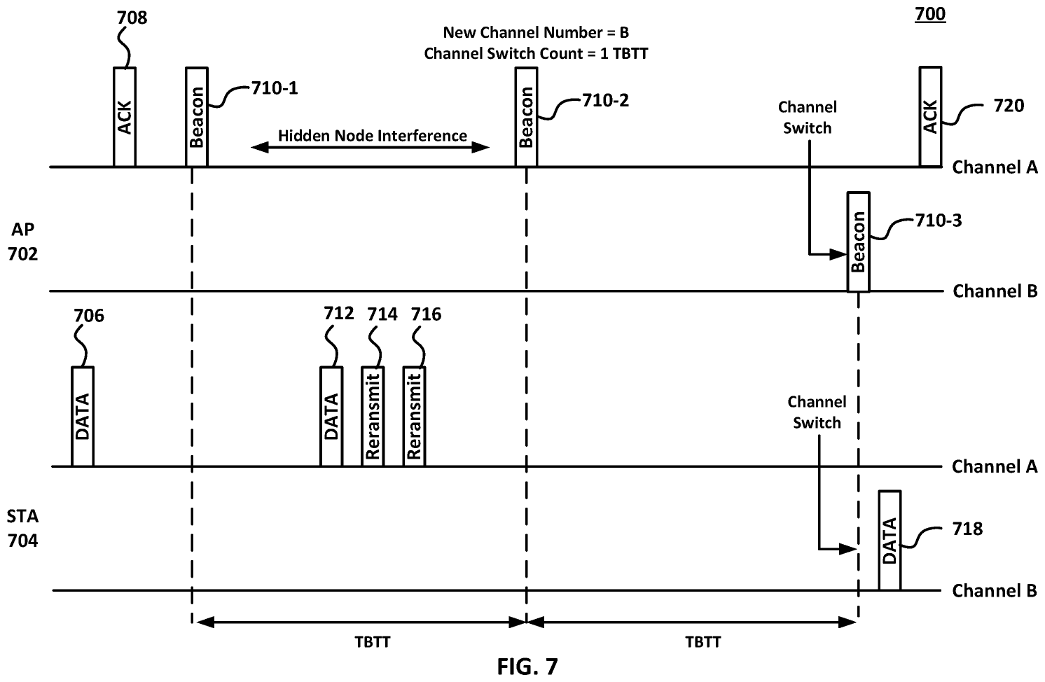

FIG. 7 is an example 700 that illustrates a procedure that may be used by an AP to switch a channel of operation (e.g., primary channel). As shown in FIG. 7, example 700 includes an AP 702 and a STA 704. STA 704 may be associated with AP 702.

In an example, AP 702 may operate on a first channel (channel A) as a primary channel. AP 702 may transmit beacon frames (e.g., 710-1, 710-2) periodically on channel A at scheduled TBTTs. In an example, a data exchange may occur between AP 702 and STA 704 on channel A. For example, STA 704 may transmit to AP 702 a data frame 706, which AP 702 may acknowledge by sending an ACK frame 708 to STA 704.

In an example, interference on channel A at AP 702 (e.g., hidden node interference) may cause multiple re-transmissions 714, 716 of a data frame 712 from STA 704 to AP 702. On detecting the multiple re-transmissions 714, 716, AP 702 may decide to switch to a new channel of operation. AP 702 may make use of information received from associated STAs and the results of measurements performed by AP 702 and/or the associated STAs to assist the selection of the new primary channel. AP 702 may select a new primary channel that is supported by all associated STAs.

After selecting a new primary channel, AP 702 informs the associated STAs that AP 702 is switching to a new primary channel. AP 702 may advertise the switch using an Extended Channel Switch Announcement element. The Extended Channel Switch Announcement element may be carried in management frames, such as a beacon frame, an Association Response frame, or an Authentication frame, for example. The Extended Channel Switch Announcement element may have a format as described above in FIG. 5. Alternatively, the switch may be advertised using a standalone action frame, such as an Extended Channel Switch Announcement frame comprising an Extended Channel Switch Announcement Action field as described in FIG. 6.

AP 702 may advertise the switch one or more times (using broadcast or unicast frames) until the channel switch time. AP 702 may schedule the switch such that all associated STA, including STAs in power save mode, have an opportunity to receive at least one announcement of the switch before the switch occurs.

In example 700, AP 702 advertises a switch to a new primary channel (channel B) in beacon frame 710-2. Beacon frame 710-2 may include an Extended Channel Switch Announcement element as described above in FIG. 5. In example 700, the Extended Channel Switch Announcement element includes a New Channel Number field that indicates channel B, and a Channel Switch Count field set to 1 TBTT. As described above, the Channel Switch Count field indicates a number of TBTTs until AP 702 switches to the new primary channel. Particularly, a Channel Switch Count field set to 1 TBBT indicates that the switch occurs immediately before the next TBTT (the scheduled transmission of the next beacon frame). As such, as shown in FIG. 7, AP 702 switches to channel B, immediately before transmitting a next beacon frame 710-3 on channel B. In an example, AP 702 transmits beacon frame 710-3 on channel B no later than a time indicated in a Switch Time field of a Max Channel Switch Time element included in beacon frame 710-2.

AP 702 may force associated STAs to stop transmissions until the channel switch takes place by setting the Channel Switch Mode field in the Extended Channel Switch Announcement element to 1.

Having received beacon frame 710-2 from AP 702, STA 704 also switches to channel B, immediately before the next TBTT. STA 704 thus receives beacon frame 710-3 and may continue its association with AP 702. Subsequently, STA 704 may continue its frame exchange with AP 702 on channel B. For example, STA 704 may transmit to AP 702 a data frame 718, which AP 702 may acknowledge by sending an ACK frame 720 to STA 704.

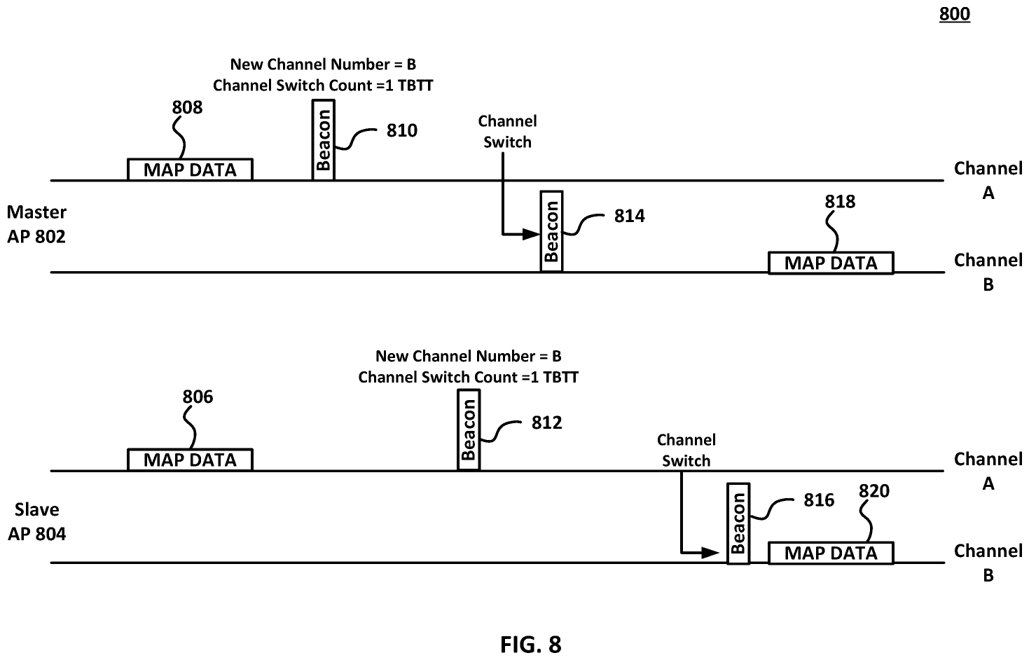

FIG. 8 is an example 800 that illustrates primary channel switching in a coordinated AP set. As shown in FIG. 8, example 800 includes an AP 802 and an AP 804. Each of APs 802 and 804 may have one or more associated STAs (not shown in FIG. 8). APs 802 and 804 may form a coordinated AP set. In an example, AP 802 may act as a master AP and AP 804 as a slave AP of the coordinated AP set. As part of the coordinated AP set, APs 802 and 804 may perform coordinated transmissions on one or more channels.

In an example, APs 802 and 804 both operate on a first channel (channel A) as a primary channel. As part of a coordinated AP set, APs 802 and 804 may coordinate their transmissions on channel A. In an example, APs 802 and 804 may coordinate to perform simultaneous transmissions 806 and 808 respectively on channel A. The simultaneous transmissions 806 and 808 may form a multi-AP transmission. The multi-AP transmission may use different transmission techniques, such as Coordinated OFDMA, Coordinated Spatial Reuse, Joint Transmission and Reception, Coordinated Beamforming, and Coordinated Time Division Multiple Access (TDMA), or a combination of two or more of the aforementioned techniques.

In an example, AP 802 may decide to switch its 0 (e.g., primary channel) from channel A to a second channel (channel B). The decision of AP 802 to switch its primary channel from channel A to channel B may be due to interference experienced by AP 802 or by one or more of its associated STAs on channel A. Alternatively or additionally, the decision of AP 802 may be due to the fact that improved multi-AP coordination between APs 802 and 804 may be achieved on channel B than on channel A.

In an example, AP 802 may wish to maintain the coordinated AP set with AP 804 after the primary channel switch. For example, AP 802 may find it advantageous to maintain the coordinated AP set with AP 804 in order to be able to perform certain multi-AP transmissions (e.g., Joint Transmission and Reception, Coordinated Beamforming, etc.).

In example 800, AP 802 transmits a beacon frame 810 including an Extended Channel Switch Announcement element. The Extended Channel Switch Announcement element may include a New Channel Number field that indicates channel B and a Channel Switch Count set to 1 TBTT. AP 802 then switches to channel B, before transmitting a next beacon frame 814 on channel B.

In example 800, AP 804 receives beacon frame 810 from AP 804. Based on the Extended Channel Switch Announcement element contained in beacon frame 810, AP 804 learns of the upcoming primary channel switch of AP 802. In an example, AP 804 decides to follow AP 802 by switching its primary channel from channel A to channel B. For example, slave AP 804 may be configured to automatically follow master AP 802. As such, similarly, AP 804 may transmit a beacon frame 812 including an Extended Channel Switch Announcement element. The Extended Channel Switch Announcement element may include a New Channel Number field that indicates channel B and a Channel Switch Count set to 1 TBTT. AP 804 then switches to channel B, before transmitting a next beacon frame 816 on channel B.

With both APs 802 and 804 operating on channel B, the coordinated AP set formed by APs 802 and 804 may be maintained. In an example, APs 802 and 804 may coordinate to perform simultaneous transmissions 818 and 820 respectively on channel B.

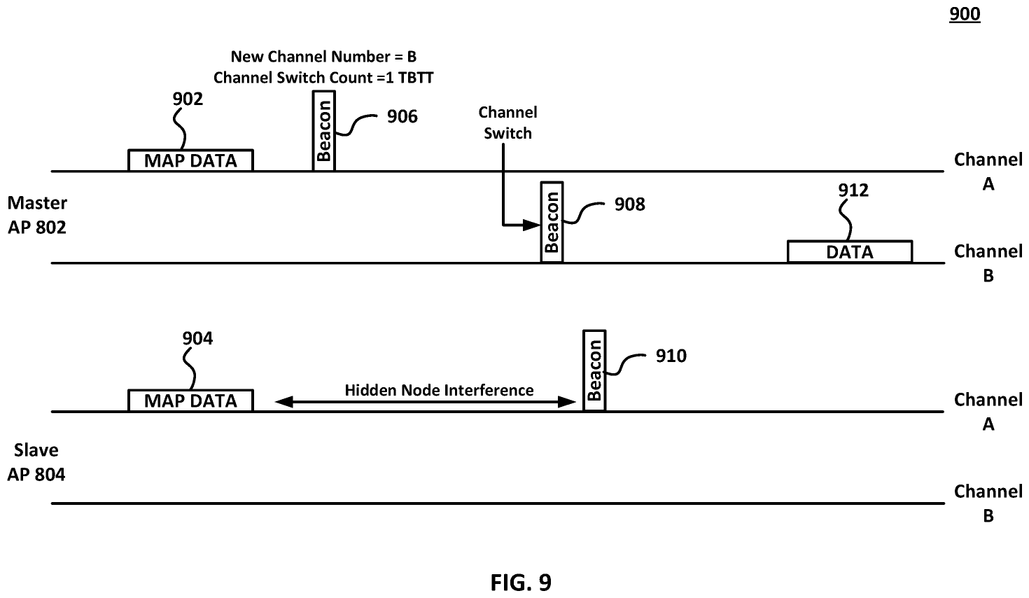

FIG. 9 is an example 900 that illustrates a potential problem that may arise in relation to primary channel switching in a coordinated AP set. Like example 800, example 900 also includes APs 802 and 804 forming a coordinated AP set. Initially, APs 802 and 804 both operate on channel A as a primary channel. In an example, APs 802 and 804 may coordinate to perform simultaneous transmissions 902 and 904 respectively on channel A.

Subsequently, as in example 800, AP 802 may decide to switch its channel of operation (e.g., primary channel) from channel A to channel B. In example 900, AP 802 transmits a beacon frame 906 including an Extended Channel Switch Announcement element. The Extended Channel Switch Announcement element may include a New Channel Number field that indicates channel B and a Channel Switch Count set to 1 TBTT. AP 802 then switches to channel B, before transmitting a next beacon frame 908 on channel B.

In an example, AP 802 may wish to maintain the coordinated AP set with AP 804 after the primary channel switch. However, in example 900, AP 804 may fail to receive beacon frame 906 or other frames advertising the primary channel switch for an extended period of time. The reception failure may be due to hidden node interference at AP 804. As a result, AP 804 does not follow AP 802 in the primary channel switch and continues to operate on channel A, including transmitting a next beacon frame 910 on channel A.

With AP 802 switching to channel B, without the knowledge of AP 804, the coordinated AP set of APs 802 and 804 operating on channel A, as well as the advantages of multi-AP coordination, are lost. For example, AP 802 may now perform only a single-AP transmission 912 on channel B. Depending on the target, transmission quality may be degraded due to the loss of the possibility of multi-AP coordination. Further, with APs 802 and 804 now operating on different primary channels, the coordinated AP set may not be re-established.

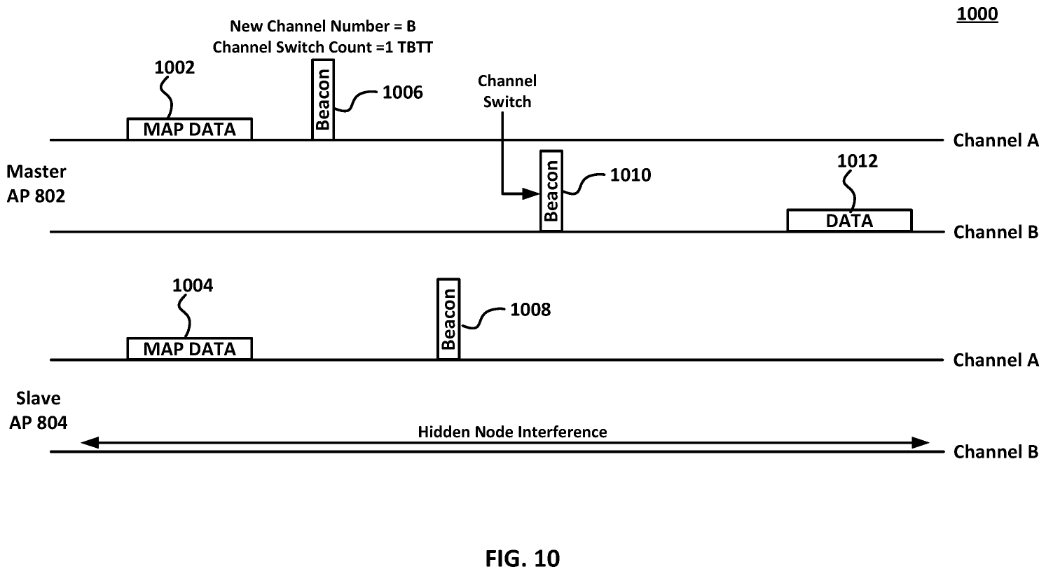

FIG. 10 is an example 1000 that illustrates another potential problem that may arise in relation to primary channel switching in a coordinated AP set. Like example 800, example 1000 also includes APs 802 and 804 forming a coordinated AP set. Initially, APs 802 and 804 both operate on channel A as a primary channel. In an example, APs 802 and 804 may coordinate to perform simultaneous transmissions 1002 and 1004 respectively on channel A.

Subsequently, as in example 800, AP 802 may decide to switch its channel of operation (e.g., primary channel) from channel A to channel B. In example 1000, AP 802 transmits a beacon frame 1006 including an Extended Channel Switch Announcement element. The Extended Channel Switch Announcement element may include a New Channel Number field that indicates channel B and a Channel Switch Count set to 1 TBTT.

In an example, AP 802 may wish to maintain the coordinated AP set with AP 804 after the primary channel switch. However, in example 1000, despite receiving beacon frame 1006 from AP 802, AP 804 may prefer to stay on channel A as primary channel. For example, AP 804 may be aware of an active hidden node interferer on channel B based on previously listening to channel B. AP 804 may thus decide not to follow AP 802 in the primary channel switch and may continue to operate on channel A, including transmitting a next beacon frame 1008 on channel A.

Subsequently, AP 802 switches to channel B, before transmitting a next beacon frame 1010 on channel B. With AP 802 switching to channel B, and AP 804 deciding to stay on channel A, the coordinated AP set of APs 802 and 804 operating on channel A, as well as the advantages of multi-AP coordination, are lost. For example, AP 802 may now perform only a single-AP transmission 1012 on channel B. Depending on the target, transmission quality may be degraded due to the loss of the possibility of multi-AP coordination. Further, with APs 802 and 804 now operating on different primary channels, the coordinated AP set may not be re-established.

Embodiments of the present disclosure, as further discussed below, address the above-described problems. In one aspect, a first AP may transmit to a second AP a first frame comprising a request to the second AP to switch a channel of operation from a first channel to a second channel. The first AP may receive from the second AP a second frame comprising a response to the request. The response may comprise an indication of acceptance or rejection of the request or an indication of a third channel. The first AP may transmit to one or more associated STAs a third frame indicating, based on the second frame, the first channel as the channel of operation or a switch of the channel of operation from the first channel to the second channel or to the third channel.

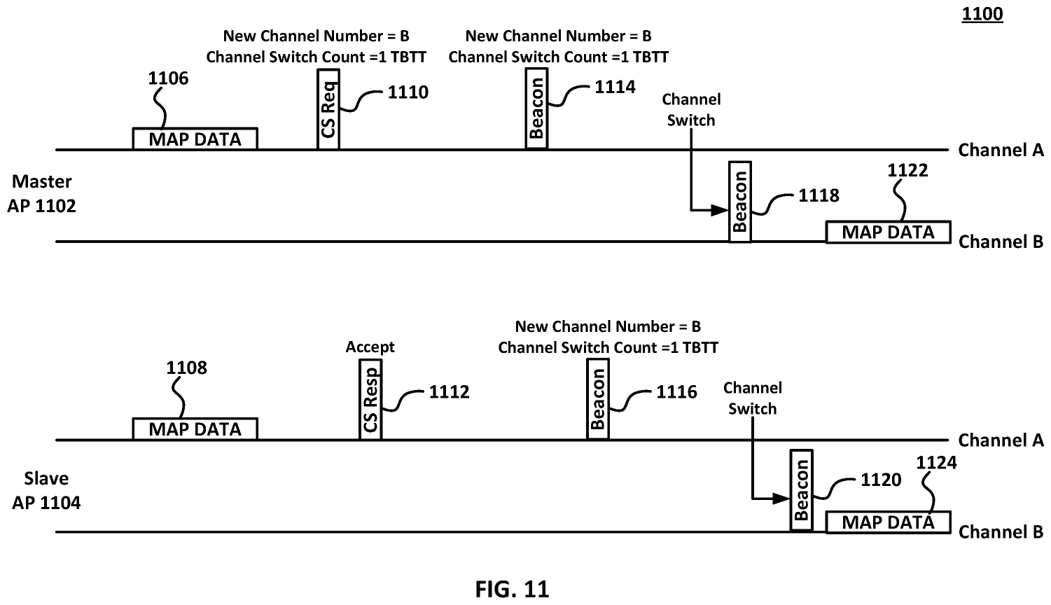

FIG. 11 is an example 1100 that illustrates a first proposed procedure for primary channel switching in a coordinated AP set according to an embodiment. As shown in FIG. 11, example 1100 includes an AP 1102 and an AP 1104. Each of APs 1102 and 1104 may have one or more associated STAs (not shown in FIG. 11). APs 1102 and 1104 may form a coordinated AP set. In an example, AP 1102 may act as a master AP and AP 1104 as a slave AP of the coordinated AP set. As part of the coordinated AP set, APs 1102 and 1104 may 1104 may perform coordinated transmissions on one or more channels.

In an example, APs 1102 and 1104 both operate on a first channel (channel A) as a primary channel. As part of a coordinated AP set, APs 1102 and 1104 may coordinate their transmissions on channel A. In an example, APs 1102 and 1104 may coordinate to perform simultaneous transmissions 1106 and 1108 respectively on channel A. The simultaneous transmissions 1106 and 1108 may form a multi-AP transmission. The multi-AP transmission may use different transmission techniques, such as Coordinated OFDMA, Coordinated Spatial Reuse, Joint Transmission and Reception, Coordinated Beamforming, and Coordinated Time Division Multiple Access (TDMA), or a combination of two or more of the aforementioned techniques.

In an example, AP 1102 may decide to switch its channel of operation (e.g., primary channel) from channel A to a second channel (channel B). The decision of AP 1102 to switch its primary channel from channel A to channel B may be due to interference experienced by AP 1102 or by one or more of its associated STAs on channel A. Alternatively or additionally, the decision of AP 1102 may be due to the fact that improved multi-AP coordination between APs 1102 and 1104 may be achieved on channel B than on channel A.

In an example, AP 1102 may wish to maintain the coordinated AP set with AP 1104 after the primary channel switch. For example, AP 1102 may find it advantageous to maintain the coordinated AP set with AP 1104 in order to be able to perform certain multi-AP transmissions (e.g., Joint Transmission and Reception, Coordinated Beamforming, etc.).

In example 1100, AP 1102 transmits a Channel Switch (CS) Request frame 1110. CS Request frame 1110 may be a broadcast frame, a multicast, or a unicast frame. As a broadcast frame, CS Request frame 1110 may be a beacon frame. As a multicast frame, CS Request frame 1110 may be addressed to multiple slave APs. In an embodiment, CS Request frame 1110 may be a trigger frame that indicates multiple slave APs. As a unicast frame, CS Request frame 1110 may be addressed to a single slave AP, such as AP 1104. In an embodiment, CS Request frame 1110 may be an individually addressed action frame.

In an embodiment, CS Request frame 1110 comprises a request to AP 1104 to switch a channel of operation (e.g., primary channel) from a first channel to a second channel. In an embodiment, CS Request frame 1110 carries channel switch request parameters.

In an embodiment, CS Request frame 1110 comprises an Extended Channel Switch Announcement action frame. The Extended Channel Switch Announcement action frame may comprise a multi-AP channel switch element indicating the request to AP 1104 to switch to channel B. In an embodiment, CS Request frame 1110 includes a New Channel Number field and a Channel Switch Count field. The New Channel Number field indicates a proposed new channel to switch to as a primary channel. The Channel Switch Count indicates a number of TBTTs until the STA sending the Channel Switch Count field switches to the new channel. In example 1100, the New Channel Number field indicates channel B and the Channel Switch Count is set to 1 TBTT.

In another embodiment, CS Request frame 1110 comprises a trigger frame, where a User Info field of the trigger frame indicates AP 1104, channel B, and a duration in which AP 1104 is requested to switch from channel A to channel B.

On receiving CS Request frame 1110, AP 1104 may respond to CS Request frame 1110 by transmitting a CS Response frame 1112. CS Response frame 1112 may comprise a response accepting or rejecting the request contained in CS Request frame 1110. CS Response frame 1112 may be a beacon frame, an action frame, or a QoS null/data frame.

In an embodiment, CS Response frame 1112 comprises an Extended Channel Switch Announcement action frame. The Extended Channel Switch Announcement action frame may comprise a multi-AP channel switch element indicating acceptance or rejection of the request to AP 1104. In example 1100, AP 1104 accepts the request from AP 1102 to switch its primary channel operation from channel A to channel B.

Subsequently, at its next TBTT, AP 1102 transmits a beacon frame 1114. In an embodiment, based on AP 1104 accepting the request from AP 1102 to switch from channel A to channel B, AP 1102 may include an Extended Channel Switch Announcement element in beacon frame 1114. The Extended Channel Switch Announcement element may have a format as described above in FIG. 5. The Extended Channel Switch Announcement element may include a New Channel Number field that indicates channel B and a Channel Switch Count set to 1 TBTT. Similarly, at is next TBTT, AP 1104 transmits a beacon frame 1116. In an embodiment, based on AP 1104 accepting the request from AP 1102 to switch from channel A to channel B, AP 1104 may include an Extended Channel Switch Announcement element in beacon frame 1116. The Extended Channel Switch Announcement element may have a format as described above in FIG. 5. The Extended Channel Switch Announcement element may include a New Channel Number field that indicates channel B and a Channel Switch Count set to 1 TBTT.

In an embodiment, AP 1102 may also include the Extended Channel Switch Announcement element in management frames, such association response frames or authentication frames, for example, communicated with STAs associating with AP 1102.

Subsequently, AP 1102 switches to channel B, before transmitting a next beacon frame 1118 on channel B. Similarly, AP 1104 switches to channel B, before transmitting a next beacon frame 1120 on channel B. With both APs 1102 and 1104 operating on channel B, the coordinated AP set formed by APs 1102 and 1104 may be maintained. In an example, APs 1102 and 1104 may coordinate to perform simultaneous transmissions 1122 and 1124 respectively on channel B.

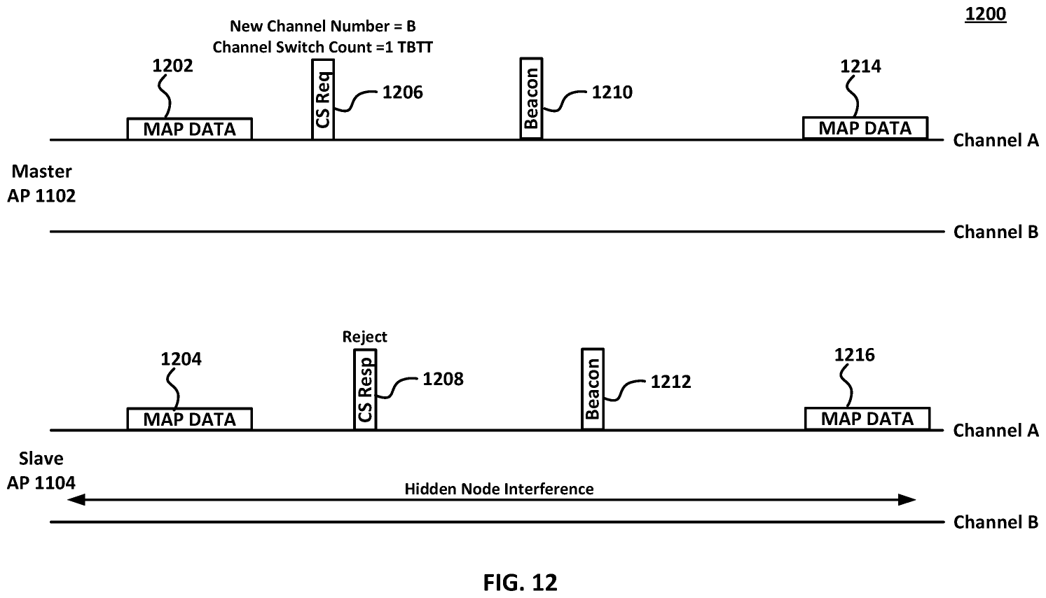

FIG. 12 is another example 1200 that illustrates the first proposed procedure for primary channel switching according to an embodiment. Like example 1100, example 1200 also includes AP 1102 and AP 1104 forming a coordinated AP set. Initially, APs 1102 and 1104 both operate on channel A as a primary channel. In an example, APs 1102 and 1104 may 1104 may coordinate to perform simultaneous transmissions 1202 and 1204 respectively on channel A.

In an example, AP 1102 may decide to switch its channel of operation (e.g., primary channel) from channel A to a second channel (channel B). The decision of AP 1102 to switch its primary channel from channel A to channel B may be due to interference experienced by AP 1102 or by one or more of its associated STAs on channel A. Alternatively or additionally, the decision of AP 1102 may be due to the fact that improved multi-AP coordination between APs 1102 and 1104 may be achieved on channel B than on channel A.

In an example, AP 1102 may wish to maintain the coordinated AP set with AP 1104 after the primary channel switch. For example, AP 1102 may find it advantageous to maintain the coordinated AP set with AP 1104 in order to be able to perform certain multi-AP transmissions (e.g., Joint Transmission and Reception, Coordinated Beamforming, etc.).

In example 1200, AP 1102 transmits a CS Request frame 1206. CS Request frame 1206 may be a broadcast frame, a multicast, or a unicast frame. As a broadcast frame, CS Request frame 1206 may be a beacon frame. As a multicast frame, CS Request frame 1206 may be addressed to multiple slave APs. In an embodiment, CS Request frame 1206 may be a trigger frame that indicates multiple slave APs. As a unicast frame, CS Request frame 1206 may be addressed to a single slave AP, such as AP 1104. In an embodiment, CS Request frame 1206 may be an individually addressed action frame.

In an embodiment, CS Request frame 1206 comprises a request to AP 1104 to switch a channel of operation (primary channel) from a first channel to a second channel. In an embodiment, CS Request frame 1206 carries channel switch request parameters.

In an embodiment, CS Request frame 1206 comprises an Extended Channel Switch Announcement action frame. The Extended Channel Switch Announcement action frame may comprise a multi-AP channel switch element indicating the request to AP 1104 to switch to channel B. In an embodiment, CS Request frame 1206 includes a New Channel Number field and a Channel Switch Count field. The New Channel Number field indicates a proposed new channel to switch to as a primary channel. The Channel Switch Count indicates a number of TBTTs until the STA sending the Channel Switch Count field switches to the new channel. In example 1200, the New Channel Number field indicates channel B and the Channel Switch Count is set to 1 TBTT.

In another embodiment, CS Request frame 1206 comprises a trigger frame, where a User Info field of the trigger frame indicates AP 1104, channel B, and a duration in which AP 1104 is requested to switch from channel A to channel B.

On receiving CS Request frame 1206, AP 1104 may respond to CS Request frame 1206 by transmitting a CS Response frame 1208. CS Response frame 1208 may comprise a response accepting or rejecting the request contained in CS Request frame 1206. CS Response frame 1208 may be a beacon frame, an action frame, or a QoS null/data frame.

In an embodiment, CS Response frame 1208 comprises an Extended Channel Switch Announcement action frame. The Extended Channel Switch Announcement action frame may comprise a multi-AP channel switch element indicating acceptance or rejection of the request to AP 1104. In example 1200, AP 1104 rejects the request from AP 1102 to switch its primary channel operation from channel A to channel B.

In an embodiment, in response to CS Response frame 1208 rejecting the switch from channel A to channel B, AP 1102 may either proceed with the channel switch or may cancel the channel switch. In example 1200, AP 1102 decides to cancel the channel switch based on CS Response frame 1208 rejecting the switch from channel A to channel B. As such, at its next TBTT, AP 1102 may transmit a beacon frame 1210 that does not advertise the channel switch. For example, beacon frame 1210 may not include an Extended Channel Switch Announcement element carried in CS Request frame 1206. Similarly, at is next TBTT, AP 1104 transmits a beacon frame 1212. Beacon frame 1212 does not advertise a channel switch by AP 1104.

With both APs 1102 and 1104 continuing to operate on channel A, the coordinated AP set formed by APs 1102 and 1104 is maintained. In an example, APs 1102 and 1104 may 1104 may coordinate to perform simultaneous transmissions 1214 and 1216 respectively on channel A.

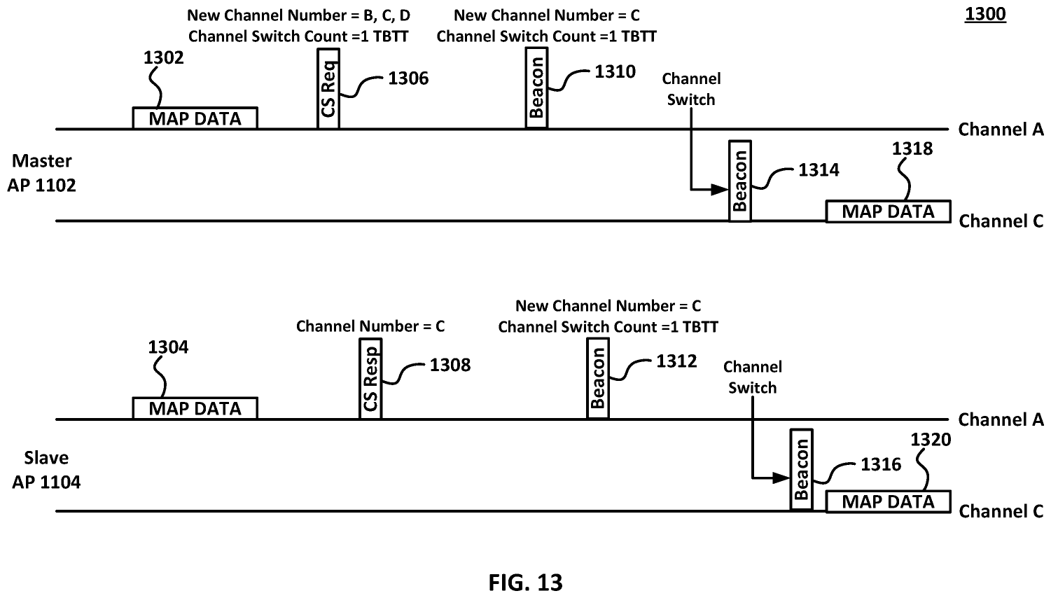

FIG. 13 is an example 1300 that illustrates a second proposed procedure for primary channel switching in a coordinated AP set according to an embodiment. As shown in FIG. 13, example 1300 also includes AP 1102 and AP 1104 forming a coordinated AP set. Initially, APs 1102 and 1104 both operate on channel A as a primary channel. In an example, APs 1102 and 1104 may coordinate to perform simultaneous transmissions 1302 and 1304 respectively on channel A.

In an example, AP 1102 may decide to switch its channel of operation (e.g., primary channel) from channel A to another channel. The decision of AP 1102 to switch its primary channel from channel A to another channel B may be due to interference experienced by AP 1102 or by one or more of its associated STAs on channel A. Alternatively or additionally, the decision of AP 1102 may be due to the fact that improved multi-AP coordination between APs 1102 and 1104 may be achieved on another channel than on channel A.

In an example, AP 1102 may wish to maintain the coordinated AP set with AP 1104 after the primary channel switch. For example, AP 1102 may find it advantageous to maintain the coordinated AP set with AP 1104 in order to be able to perform certain multi-AP transmissions (e.g., Joint Transmission and Reception, Coordinated Beamforming, etc.).

In example 1300, AP 1102 transmits a CS Request frame 1306. CS Request frame 1306 may be a broadcast frame, a multicast, or a unicast frame. As a broadcast frame, CS Request frame 1306 may be a beacon frame. As a multicast frame, CS Request frame 1306 may be addressed to multiple slave APs. In an embodiment, CS Request frame 1306 may be a trigger frame that indicates multiple slave APs. As a unicast frame, CS Request frame 1306 may be addressed to a single slave AP, such as AP 1104. In an embodiment, CS Request frame 1306 may be an individually addressed action frame.

In an embodiment, CS Request frame 1306 comprises a plurality of requests, with each request requesting AP 1104 to switch a channel of operation (e.g., primary channel) from a first channel (e.g., channel A) to a respective second channel of a first set of channels (e.g., channels B, C, and D). In an embodiment, CS Request frame 1306 carries channel switch request parameters for each channel of the first set of channels.

In an embodiment, CS Request frame 1306 comprises an indication of the first set of channels. The first set of channels represents channels to each of which AP 1104 may wish to switch as a primary channel from channel A. In an embodiment, CS Request frame 1306 comprises an Extended Channel Switch Announcement action frame. The Extended Channel Switch Announcement action frame may comprise a plurality of multi-AP channel switch elements for each channel of the first set of channels. In an embodiment, for each channel of the first set of channels, CS Request frame 1306 includes a New Channel Number field and a Channel Switch Count field. The New Channel Number field indicates the channel number of the channel. The Channel Switch Count indicates a number of TBTTs until the STA sending the Channel Switch Count field switches to the channel. In another embodiment, CS Request frame 1306 includes a single Channel Switch Count field for all channels of the first set of channels indicated in CS Request frame 1306.

In another embodiment, CS Request frame 1306 comprises a trigger frame. The trigger frame includes a respective User Info field for each channel of the first set of channels indicated in CS Request frame 1306. Each User Info field of the trigger frame indicates AP 1104, a respective channel number of a respective channel of the first set of channels (e.g., channel B, C, or D), and a duration in which AP 1104 is requested to switch from channel A to the indicated respective channel.

On receiving CS Request frame 1306, AP 1104 may respond to CS Request frame 1306 by transmitting a CS Response frame 1308. CS Response frame 1308 may comprise a response accepting one of the plurality of requests contained in CS Request frame 1306, indicating a second set of channels, or rejecting all rejecting all requests contained in CS Request frame 1306. The second set of channels may or may not be a subset of the first set of channels. In example 1300, AP 1104 accepts the request to switch to channel C contained in CS Request frame 1306 by indicating channel C in CS Response frame 1308. CS Response frame 1308 may be a beacon frame, an action frame, or a QoS null/data frame.

In an embodiment, CS Response frame 1308 comprises an Extended Channel Switch Announcement action frame. In an embodiment, the Extended Channel Switch Announcement action frame may comprise one or more multi-AP channel switch element. In an embodiment, when CS Response frame 1308 accepts one of the requests of CS Request frame 1306, the Extended Channel Switch Announcement action frame comprises a multi-AP channel switch element indicating the channel associated with the accepted request. In an embodiment, when CS Response frame 1308 indicates a second set of channels, the Extended Channel Switch Announcement action frame comprises a plurality of multi-AP channel switch elements each indicating a respective channel of the second set of channels. In an embodiment, when CS Response frame 1308 rejects all requests contained in CS Request frame 1306, the Extended Channel Switch Announcement action frame comprises a plurality of multi-AP channel switch elements each indicating a respective channel of the first set of channels being rejected. In another embodiment, a single multi-AP channel switch element may be used to indicate rejection of all requests contained in CS Request frame 1306.

Returning to example 1300, subsequently, at its next TBTT, AP 1102 transmits a beacon frame 1310. In an embodiment, based on AP 1104 accepting the request from AP 1102 to switch from channel A to channel C, AP 1102 may include an Extended Channel Switch Announcement element in beacon frame 1310. The Extended Channel Switch Announcement element may have a format as described above in FIG. 5. The Extended Channel Switch Announcement element may include a New Channel Number field that indicates channel C and a Channel Switch Count set to 1 TBTT. Similarly, at is next TBTT, AP 1104 transmits a beacon frame 1312. In an embodiment, based on AP 1104 accepting the request from AP 1102 to switch from channel A to channel C, AP 1104 may include an Extended Channel Switch Announcement element in beacon frame 1312. The Extended Channel Switch Announcement element may have a format as described above in FIG. 5. The Extended Channel Switch Announcement element may include a New Channel Number field that indicates channel C and a Channel Switch Count set to 1 TBTT.

In an embodiment, AP 1102 may also include the Extended Channel Switch Announcement element in management frames, such association response frames or authentication frames, for example, communicated with STAs associating with AP 1102.

In an embodiment, where CS Response frame 1308 indicates a second set of channels (e.g., channels B, C, and D), AP 1102 may accept a channel (e.g., channel C) of the second set of channels by indicating the accepted channel in the Extended Channel Switch Announcement element in beacon frame 1310. Based on receiving beacon frame 1310, AP 1104 learns the channel accepted by AP 1102 and may advertise this channel in its beacon frame 1312.

Subsequently, AP 1102 switches to channel C, before transmitting a next beacon frame 1314 on channel C. Similarly, AP 1104 switches to channel C, before transmitting a next beacon frame 1316 on channel C. With both APs 1102 and 1104 operating on channel C, the coordinated AP set formed by APs 1102 and 1104 may be maintained. In an example, APs 1102 and 1104 may coordinate to perform simultaneous transmissions 1318 and 1320 respectively on channel C.

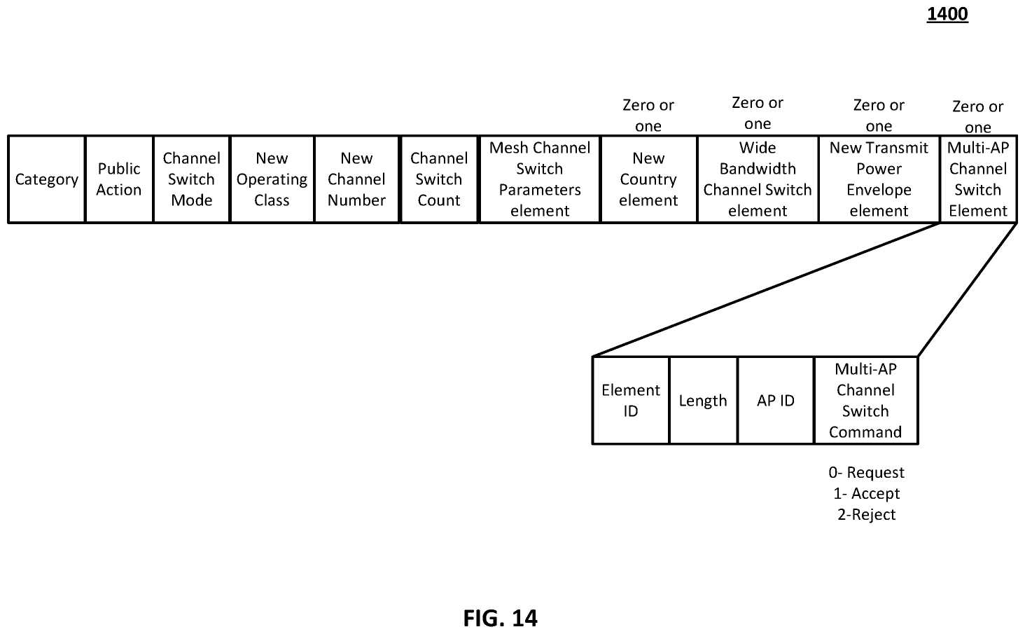

FIG. 14 illustrates an example Extended Channel Switch Announcement Action field 1400 according to an embodiment. Extended Channel Switch Announcement Action field 1400 may be carried in an Extended Channel Switch Announcement action frame according to embodiments. The Extended Channel Switch Announcement action frame may be a CS Request frame or a CS Response frame.

As shown in FIG. 14, Extended Channel Switch Announcement Action field 1400 may 1400 may be a modified version of Extended Channel Switch Announcement Action field 600 described above. Specifically, like Extended Channel Switch Announcement Action field 600, Extended Channel Switch Announcement Action field 1400 also includes a Category field, a Public Action field, a Channel Switch Mode field, a New Operating Class field, a New Channel Number field, a Mesh Channel Switch Parameters element, a New Country element, a Wide Bandwidth Channel Switch element, and a New Transmit Power Envelope element. These fields are described above with reference to FIG. 6.

In addition, Extended Channel Switch Announcement Action field 1400 may include one or more multi-AP channel switch element. The multi-AP channel switch element includes an Element ID field, a Length field, an AP ID field, and a multi-AP channel switch command field. The Element ID field identifies the element as a multi-AP channel switch element. The Length field indicates the length of the element, which allows a receiving AP to know where the next element starts. The AP ID field indicates the AP that is targeted by the multi-AP channel switch element. If the multi-AP channel switch element is included in a CS Request frame that is intended for a single AP, the AP ID field may be optional as the intended AP can also be indicated in another field of the CS Request frame.

The multi-AP channel switch command field is set depending on whether the multi-AP channel switch element is part of a CS Request frame or a CS Response frame, and for a CS Response frame, depending on whether the multi-AP channel switch element accepts or rejects a respective channel switch request from another AP. In an embodiment, the multi-AP channel switch command field may be set to 0 when the multi-AP channel switch element is a part of a CS Request frame; to 1 when the multi-AP channel switch element is a part of a CS Response frame and the multi-AP channel switch element accepts a requested channel switch to the channel indicated in the New Channel Number field of Extended Channel Switch Announcement Action field 1400; and to 2 when the multi-AP channel switch element is a part of a CS Response frame and the multi-AP channel switch element rejects a requested channel switch to the channel indicated in the New Channel Number field of Extended Channel Switch Announcement Action field 1400.

As described above, in an embodiment, an Extended Channel Switch Announcement action frame may comprise a plurality of multi-AP channel switch elements for each channel of a first set of channels indicated by the AP requesting the channel switch or of a second set of channels indicated by the AP responding to a channel switch request. In such an embodiment, the Extended Channel Switch Announcement action frame may comprise a plurality of fields, such as Extended Channel Switch Announcement Action field 1400, with each field comprising a respective multi-AP channel switch element.

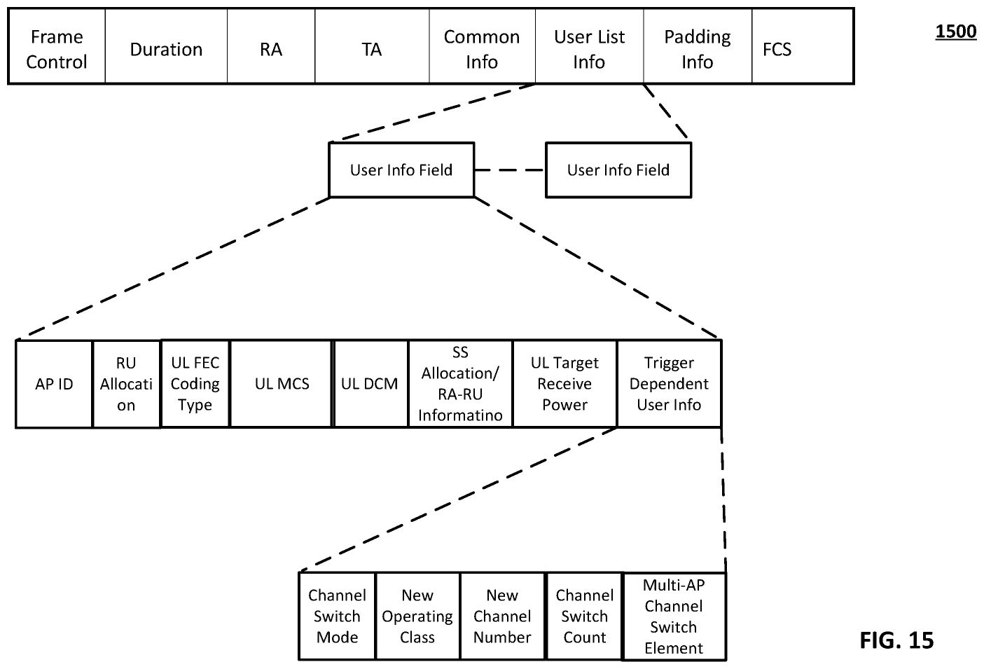

FIG. 15 illustrates an example CS Request frame 1500 according to an embodiment. CS Request frame 1500 may be used by an AP to request a channel switch from one or more APs. As shown in FIG. 15, CS Request frame 1500 may be a modified version of a basic trigger frame. Specifically, CS Request frame 1500 may include a variable User List Info field comprising a plurality of User Info fields, each for a respective AP targeted by CS Request frame 1500. It is noted that when CS Request frame 1500 indicates a set of channels as described above, the User List Info field may include multiple User Info fields for each target AP, one for each indicated channel.

As shown in FIG. 15, in an embodiment, a Trigger Dependent User Info subfield of a User Info field may include a Channel Switch Mode field, a New Operating Class field, a New Channel Number field, a Channel Switch Count field, and a multi-AP channel switch element. The Channel Switch Mode field, New Operating Class field, New Channel Number field, and Channel Switch Count field may be as described above in FIG. 5. The multi-AP channel switch element may be as described above in FIG. 14.

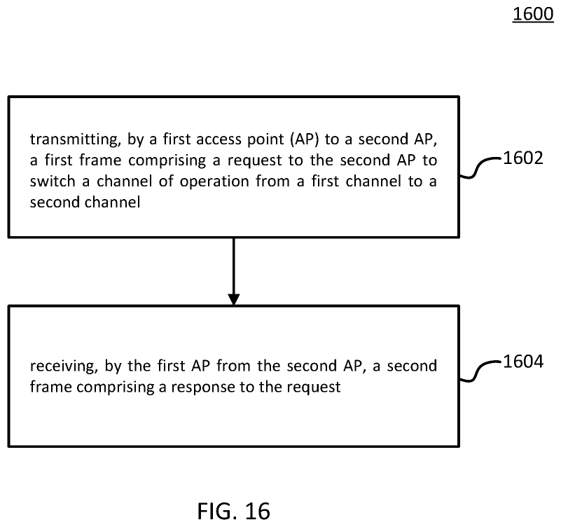

FIG. 16 illustrates an example process 1600 according to an embodiment. Example process 1600 may be performed by a first AP requesting a primary channel switch from a second AP. The first AP and the second AP may be members of a coordinated AP set. For example, the first AP may be a master AP and the second AP may be a slave AP of the coordinated AP set, or vice versa.

As shown in FIG. 16, in step 1602, process 1600 includes transmitting, by the first AP to the second AP, a first frame comprising a request to the second AP to switch a channel of operation (e.g., primary channel) from a first channel to a second channel. In an embodiment, the first frame comprises a trigger frame, an action frame, or a beacon frame.

In an embodiment, the first frame may comprise a CS Request frame as described above. In an embodiment, the first frame may comprise an Extended Channel Switch Announcement action frame. The Extended Channel Switch Announcement action frame may comprise a multi-AP channel switch element indicating the request to the second AP. In another embodiment, the first frame may comprise a trigger frame. The trigger frame may comprise a User Info field indicating the second AP, the second channel, and a duration in which the second AP is requested to switch from the first channel to the second channel.

In an embodiment, the first frame comprises an indication of a first set of channels. In an embodiment, the first frame may comprise an Extended Channel Switch Announcement action frame comprising a plurality of multi-AP channel switch elements. In another embodiment, the first frame may comprise a trigger frame. The trigger frame may comprise a plurality of User Info fields each indicating the second AP, a respective channel of the first set of channels, and a duration in which the second AP is requested to switch from the first channel to the respective channel.

Step 1604 includes receiving, by the first AP from the second AP, a second frame comprising a response to the request. In an embodiment, the second frame comprises an action frame or a beacon frame.

In an embodiment, the second frame comprises a CS Response frame as described above. In an embodiment, the second frame comprises an Extended Channel Switch Announcement action frame. The Extended Channel Switch Announcement action frame may comprise a multi-AP channel switch element indicating acceptance or rejection of the request to the second AP.

In an embodiment, where the first frame comprises an indication of a first set of channels, the second frame comprises an indication of a channel from the first set of channels.

In another embodiment, where the first frame comprises an indication of a first set of channels, the second frame comprises an indication of a second set of channels. The second set of channels may or may not be a subset of the first set of channels. In an embodiment, process 1600 may further comprise transmitting, by the first AP, a third frame comprising an indication of a channel from the second set of channels.

In an embodiment, the response in the second frame comprises a rejection of the request to switch from the first channel to the second channel.

In an embodiment, process 1600 may further comprise transmitting, by the first AP, to one or more associated stations, a fourth frame comprising an extended channel switch announcement element. The fourth frame may comprise a beacon frame, an association response frame, an authentication response frame, or an action frame.

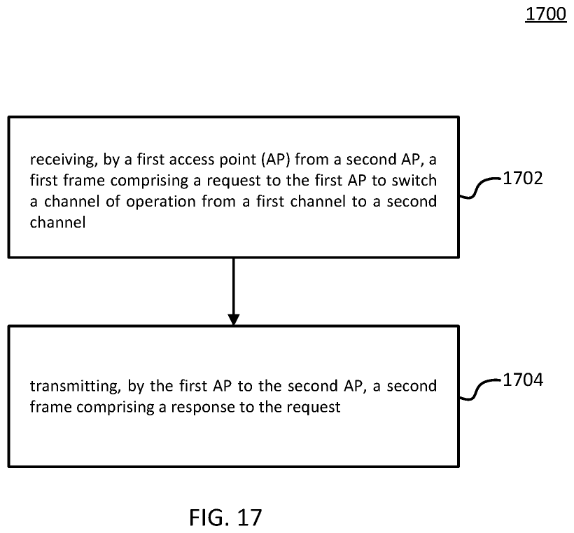

FIG. 17 illustrates another example process according to an embodiment. Example process 1700 may be performed by a first AP receiving a primary channel switch request from a second AP. The first AP and the second AP may be members of a coordinated AP set. For example, the first AP may be a master AP and the second AP may be a slave AP of the coordinated AP set, or vice versa.

As shown in FIG. 17, in step 1702, process 1700 includes receiving, by the first AP from the second AP, a first frame comprising a request to the first AP to switch a channel of operation from a first channel to a second channel. In an embodiment, the first frame comprises a trigger frame, an action frame, or a beacon frame.

In an embodiment, the first frame may comprise a CS Request frame as described above. In an embodiment, the first frame may comprise an Extended Channel Switch Announcement action frame. The Extended Channel Switch Announcement action frame may comprise a multi-AP channel switch element indicating the request to the first AP. In another embodiment, the first frame may comprise a trigger frame. The trigger frame may comprise a User Info field indicating the first AP, the second channel, and a duration in which the first AP is requested to switch from the first channel to the second channel.

In an embodiment, the first frame comprises an indication of a first set of channels. In an embodiment, the first frame may comprise an Extended Channel Switch Announcement action frame comprising a plurality of multi-AP channel switch elements. In another embodiment, the first frame may comprise a trigger frame. The trigger frame may comprise a plurality of User Info fields each indicating the first AP, a respective channel of the first set of channels, and a duration in which the first AP is requested to switch from the first channel to the respective channel.

Step 1604 includes transmitting, by the first AP to the second AP, a second frame comprising a response to the request. In an embodiment, the second frame comprises an action frame or a beacon frame.

In an embodiment, the second frame comprises a CS Response frame as described above. In an embodiment, the second frame comprises an Extended Channel Switch Announcement action frame. The Extended Channel Switch Announcement action frame may comprise a multi-AP channel switch element indicating acceptance or rejection of the request to the first AP.

In an embodiment, where the first frame comprises an indication of a first set of channels, the second frame comprises an indication of a channel from the first set of channels.

In another embodiment, where the first frame comprises an indication of a first set of channels, the second frame comprises an indication of a second set of channels. The second set of channels may or may not be a subset of the first set of channels. In an embodiment, process 1700 may further comprise receiving, by the first AP from the second AP, a third frame comprising an indication of a channel from the second set of channels.

In an embodiment, the response in the second frame comprises a rejection of the request to switch from the first channel to the second channel.

In an embodiment, process 1700 may further comprise transmitting, by the first AP, to one or more associated stations, a fourth frame comprising an extended channel switch announcement element. The fourth frame may comprise a beacon frame, an association response frame, an authentication response frame, or an action frame.

What is claimed is:

1. A first access point (AP) comprising:
one or more processors; and
memory storing instructions that, when executed by the one or more processors, cause the first AP to:
transmit, to a second AP, a first frame comprising a request to the second AP to switch a channel of operation from a first channel to a second channel; and
receive, from the second AP, a second frame comprising a response to the request.

2. The first AP of claim 1, wherein the first AP and the second AP are members of a coordinated AP set.

3. The first AP of claim 1, wherein the first frame comprises a first indication of a first set of channels.

4. The first AP of claim 3, wherein the second frame comprises a second indication of a channel from the first set of channels.

5. The first AP of claim 3, wherein the second frame comprises a second indication of a second set of channels.

6. The first AP of claim 5, wherein the second set of channels is a subset of the first set of channels.

7. The first AP of claim 5, wherein the instructions, when executed by the one or more processors, further cause the first AP to transmit a third frame comprising a third indication of a channel from the second set of channels.

8. The first AP of claim 1, wherein the response comprises a rejection of the request to switch the channel of operation from the first channel to the second channel.

9. The first AP of claim 1, wherein the first frame comprises an extended channel switch announcement action frame, the extended channel switch announcement action frame comprising a multi-AP channel switch element indicating the request to the second AP.

10. The first AP of claim 1, wherein the first frame comprises a trigger frame, the trigger frame comprising a user information field indicating the second AP, the second channel, and a duration in which the second AP is requested to switch from the first channel to the second channel.

11. The first AP of claim 1, wherein the second frame comprises an extended channel switch announcement action frame, the extended channel switch announcement action frame comprising a multi-AP channel switch element indicating acceptance or rejection of the request to the second AP.

12. The first AP of claim 1, wherein the instructions, when executed by the one or more processors, further cause the first AP to transmit, to one or more associated stations, a third frame comprising an extended channel switch announcement element.

13. The first AP of claim 12, wherein the third frame comprises a beacon frame, an association response frame, an authentication response frame, or an action frame.

14. The first AP of claim 1, wherein the first AP comprises a master AP and the second AP comprises a slave AP.

15. A first access point (AP) comprising:
one or more processors; and
memory storing instructions that, when executed by the one or more processors, cause the first AP to:
receive, from a second AP, a first frame comprising a request to switch a channel of operation from a first channel to a second channel; and
transmit, to the second AP, a second frame comprising a response to the request.

16. The first AP of claim 15, wherein the first frame comprises a first indication of a first set of channels.

17. The first AP of claim 16, wherein the second frame comprises a second indication of a channel from the first set of channels.

18. The first AP of claim 16, wherein the second frame comprises a second indication of a second set of channels.

19. The first AP of claim 15, wherein the second frame comprises an extended channel switch announcement action frame, the extended channel switch announcement action frame comprising a multi-AP channel switch element indicating acceptance or rejection of the request from the second AP.

20. A non-transitory computer-readable medium comprising instructions that, when executed by one or more processors, cause a first access point (AP) to:
transmit, to a second AP, a first frame comprising a request to the second AP to switch a channel of operation from a first channel to a second channel; and
receive, from the second AP, a second frame comprising a response to the request.
